(19) United States
(12) Patent Application Publication
(10) Pub. No.: US 2021/0268758 A1
(43) Pub. Date: Sep. 2, 2021

(54) REINFORCED TIRE SIPE BLADE

(71) Applicant: Bridgestone Americas Tire Operations, LLC, Nashville, TN (US)

(72) Inventors: David Matthew Severyn, Uniontown, OH (US); Seth Montgomery Ricks, Canton, OH (US); Justin Michael Gehres, Uniontown, OH (US)

(21) Appl. No.: 17/187,728

(22) Filed: Feb. 26, 2021

Related U.S. Application Data
(60) Provisional application No. 62/982,866, filed on Feb. 28, 2020.

(51) Int. Cl. B29D 30/06

(52) U.S. Cl. CPC B29D 30/0606; B29D 2030/0613

(57) ABSTRACT

A tire sipe blade is provided comprising a mold engagement portion and a molding portion. The mold engagement portion and the molding portion comprise a first reinforced end portion having a circumferential thickness T_{R1}. A first tapered portion extends from the first reinforced end portion and has an axial length L_{T1}. An unreinforced main portion extends from the first tapered portion and has a circumferential thickness T_{U}, wherein the thickness T_{R1} is greater than the thickness T_{U}. Additionally, a circumferential thickness of the first tapered portion decreases along its length L_{T1}, from the first reinforced end portion to the unreinforced main portion, from the thickness T_{R1} to the thickness T_{U}.

### CROSS-REFERENCE TO RELATED APPLICATIONS

This application claims priority from U.S. Provisional Patent Application No. 62/982,866, filed on 28 Feb. 2020, which is incorporated by reference herein in its entirety.

### BACKGROUND

Tire sipes are formed in a tire via the use of tire sipe blades during the tire molding and curing process. Tire sipe blades endure various loads during tire mold production and tire molding. For example, such loads may be exerted on a sipe blade during one or more of a tire mold casting, a tire de-molding, or a tire mold cleaning. Sipe blades arranged at certain positions on a tire mold may be at risk of a failure upon application of such loads, including one or both of a material yield or a fracture. For example, due to a curvature of a radially inner surface of a shoulder-forming portion of a tire mold, a sipe blade engaged at this portion may not wholly engage within the tire mold. Specifically, an axially outer portion of the sipe blade may not be supported by the mold or by another molding component, and thus, the portion may be susceptible to a material yield or a failure upon loading.

What is needed is a sipe blade having at least one reinforced portion comprising an increased sipe blade thickness at a location vulnerable to sipe blade failure upon a loading.

### SUMMARY

In one implementation, a tire sipe blade is provided comprising a mold engagement portion and a molding portion. The mold engagement portion and the molding portion comprise a first reinforced end portion having a circumferential thickness T_{R1}. A first tapered portion extends from the first reinforced end portion and has an axial length L_{T1}. An unreinforced main portion extends from the first tapered portion and has a circumferential thickness T_{U}, wherein the thickness T_{R1} is greater than the thickness T_{U}. Additionally, a circumferential thickness of the first tapered portion decreases along its length L_{T1}, from the first reinforced end portion to the unreinforced main portion, from the thickness T_{R1} to the thickness T_{U}.

In another implementation, a tire sipe blade is provided comprising a mold engagement portion and a molding portion. The mold engagement portion and the molding portion comprise a first reinforced end portion having a circumferential thickness T_{R1}. A first tapered portion extends from the first reinforced end portion and has an axial length L_{T1}. An unreinforced main portion extends from the first tapered portion and has an axial length L_{U} and a circumferential thickness T_{U}, wherein the thickness T_{R1} is greater than the thickness T_{U}. A circumferential thickness of the first tapered portion decreases along its length L_{T1}, from the first reinforced end portion to the unreinforced main portion, from the thickness T_{R1} to the thickness T_{U}. The sipe blade further comprises a central reinforced portion having a first end and a second end separated from the first reinforced end portion by an axial distance D, wherein the sipe blade has an axial length L_{B} and the distance D is less than the length L_{B}. A first central tapered portion extends from the first end of the central reinforced portion to the unreinforced main portion. A second central tapered portion extends from the second end of the central reinforced portion to the unreinforced main portion.

In a further implementation, a tire sipe blade is provided comprising a mold engagement portion and a molding portion. The mold engagement portion and the molding portion comprise a first reinforced end portion having a circumferential thickness T_{R1}. A first tapered portion extends from the first reinforced end portion and has an axial length L_{T1}. An unreinforced main portion extends from the first tapered portion and has a circumferential thickness T_{U}, wherein the thickness T_{R1} is greater than the thickness T_{U}. A circumferential thickness of the first tapered portion decreases along its length L_{T1}, from the first reinforced end portion to the unreinforced main portion, from the thickness T_{R1} to the thickness T_{U}. A second tapered portion extends from the unreinforced main portion and has an axial length L_{T2}. A second reinforced end portion extends from the second tapered portion and has a circumferential thickness T_{R2}, wherein the thickness T_{R2} is greater than the thickness T_{U}. A circumferential thickness of the second tapered portion increases along its length L_{T2}, from the unreinforced main portion to the second reinforced end portion, from the thickness T_{U} to the thickness T_{R2}.

### BRIEF DESCRIPTION OF DRAWINGS

Features, objects, and advantages other than those set forth above will become more readily apparent when consideration is given to the detailed description below. Such detailed description makes reference to the following drawings.

FIG. 1A depicts a section view of a tire mold.

FIG. 1B depicts a section view of a tire mold.

FIG. 2 depicts an elevation view of a reinforced tire sipe blade.

FIG. 3A depicts an elevation view of a reinforced tire sipe blade.

FIG. 3B depicts a plan view of the sipe blade of FIG. 3A.

FIG. 3C depicts a partial plan view of the sipe blade of FIG. 3B.

FIG. 4A depicts an elevation view of a reinforced tire sipe blade.

FIG. 4B depicts a plan view of the sipe blade of FIG. 4A.

FIG. 4C depicts a partial plan view of the sipe blade of FIG. 4B.

FIG. 4D depicts a partial plan view of the sipe blade of FIG. 4B.

FIG. 5A depicts an elevation view of a reinforced tire sipe blade.

FIG. 5B depicts a plan view of the sipe blade of FIG. 5A.

FIG. 5C depicts a partial plan view of the sipe blade of FIG. 5B.

FIG. 5D depicts a partial plan view of the sipe blade of FIG. 5B.

FIG. 6A depicts an elevation view of a reinforced tire sipe blade.

FIG. 6B depicts a plan view of the sipe blade of FIG. 6A.

FIG. 6C depicts a partial plan view of the sipe blade of FIG. 6B.

FIG. 6D depicts a partial plan view of the sipe blade of FIG. 6B.

FIG. 6E depicts a partial plan view of the sipe blade of FIG. 6B.

### DETAILED DESCRIPTION

The structures illustrated in the drawings include implementations of the features recited in the claims. The illustrated structures thus include implementations of how a person of ordinary skill in the art can make and use the claimed implementations. These implementations are described to meet the enablement and best mode requirements of the patent statue without imposing limitations that are not recited in the claims. One or more of the features of one implementation may be used in combination with, or as a substitute for, one or more features of another as needed for any particular implementation of the implementations described herein.

A conventional tire sipe blade may be manufactured by stamping a sheet of a material having a substantially constant material thickness. In this disclosure, the term “substantially” is defined as largely, but not necessarily wholly what is specified (and includes what is specified; e.g., substantially constant includes constant), as understood by a person of ordinary skill in the art. The sheet of the material may possess material properties to provide a desired strength, stability, and durability to the sipe blade. For example, the material may comprise a stainless steel. Alternatively, a sipe blade may be manufactured by three-dimensional printing methods using similar materials configured for use in three-dimensional printers. Regardless of a desired shape of a sipe blade, such as one of substantially linear or curvilinear, after manufacture a stamped sipe blade possesses a substantially constant material thickness along an axial length and a radial height of the sipe blade, wherein the thickness of the stamped sipe blade is less than the material thickness of the sheet of the material.

When stamping a sheet of a material to manufacture a reinforced tire sipe blade, a resulting reinforced sipe blade comprises at least one reinforced portion and at least one unreinforced portion. The at least one reinforced portion of the sipe blade retains one of a material thickness of the sheet of the material or a material thickness that is less than the sheet of the material. The at least one unreinforced portion comprises a material thickness that is less than the material thickness of the at least one reinforced portion. That is, the at least one unreinforced portion is thinner than the at least one reinforced portion. For example, the at least one reinforced portion may comprise a material thickness of 1.00 mm, while the unreinforced portion may comprise a material thickness of 0.60 mm.

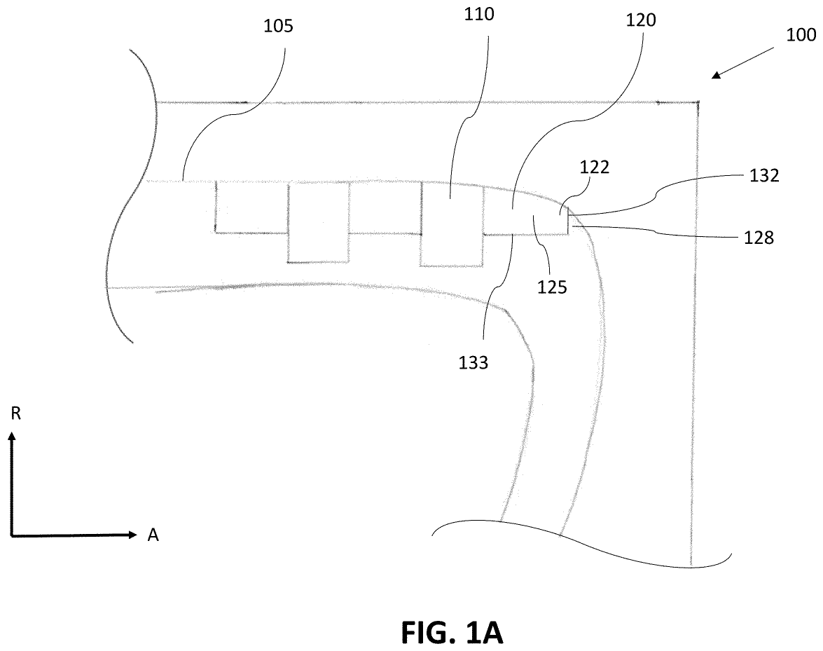

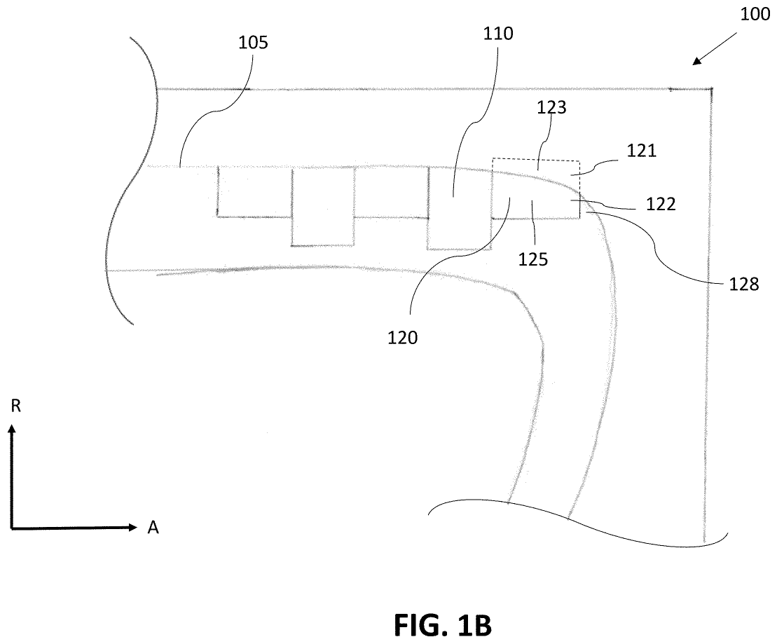

FIGS. 1A-6E include axes identified as “C,” “R,” or “A.” The C-axis represents a circumferential direction in a tire mold 100 corresponding to a circumferential direction of a tire. The R-axis represents a radial direction in the mold 100 corresponding to a radial direction of a tire. The A-axis represents an axial direction in the mold 100 corresponding to an axial direction of a tire.

FIG. 1A illustrates a section view of an implementation of a tire mold 100. The mold 100 comprises a plurality of tire molding components arranged within a radially inner surface 105 of the mold 100. The term “radially inner” or a variation of the term refers to a position toward a tire molding material in the mold 100 (and likewise toward a radially inner direction/radial center of a tire). The tire molding components may include, but are not limited to, a groove-molding component 110 contiguous to a reinforced tire sipe blade 120 positioned along a circumferential shoulder rib-forming portion of the mold 100. Alternative implementations of a position of the sipe blade 120 may be contemplated, including along a circumferential intermediate rib-forming portion or along a circumferential center rib-forming portion.

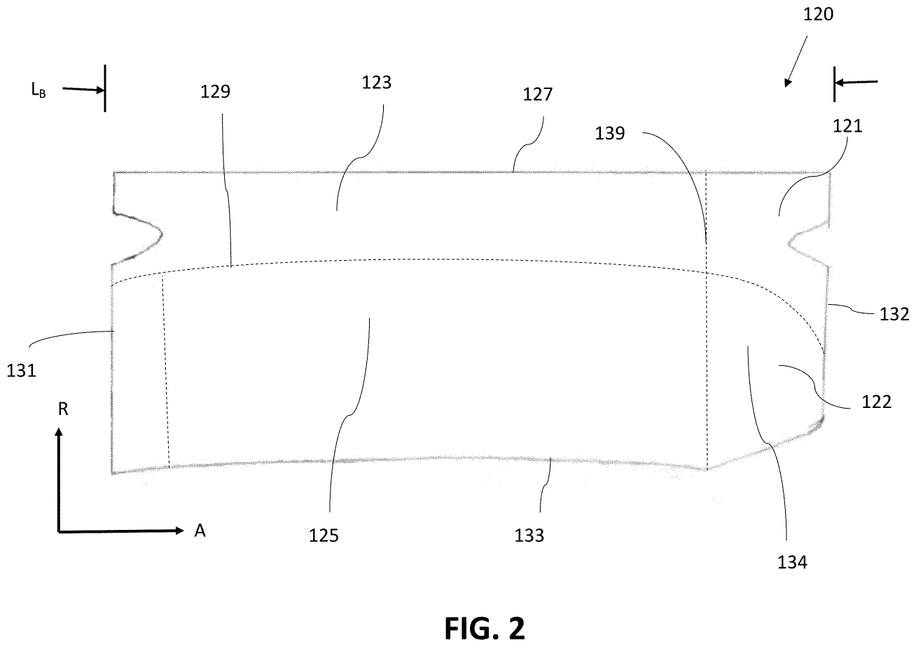

Referring to FIG. 1B and FIG. 2, the sipe blade 120 comprises a mold engagement portion 123 and a molding portion 125. The mold engagement portion 123 comprises a portion of the sipe blade 120 that engages the mold 100 such that it is recessed and secured within the mold 100. The mold engagement portion 123 comprises a radially outer portion of the sipe blade 120 having an axial length L_{B} of the sipe blade 120 that extends axially from an axially inner edge 131 to an axially outer edge 132 of the sipe blade 120. The term “radially outer” or a variation of the term refers to a position toward an external surface of the mold 100 (and likewise in the direction radially away from the radial center of a tire). The term “axially inner” or a variation of the term refers to a position toward an axial center of the mold 100 (and likewise in a direction toward an axial centerline of a tire). The term “axially outer” or a variation of the term refers to a position away from an axial center of the mold 100 (and likewise in a direction away from the centerline of a tire) and toward a sidewall-forming portion of the mold 100. The axially inner edge 131 may extend one of parallel to the radial direction R or biased relative to the radial direction R. The axially outer edge 132 may extend one of parallel to the radial direction R or biased relative to the radial direction R. The axially inner edge 131 and the axially outer edge 133 may be one of parallel or biased relative to one another.

The molding portion 125 comprises a radially inner portion of the sipe blade 120 extending the length L_{B} of the sipe blade 120. The molding portion 125 comprises a portion of the sipe blade 120 that protrudes radially inwardly from the mold 100 and is exposed to a molding material during a molding of a tire, and thus, forms a sipe within a tread of the tire.

Referring again to FIG. 2, the mold engagement portion 123 includes a radial height H_{E} that extends from a radially outer edge 127 of the sipe blade 120 to a radial demarcation line 129. The radially outer edge 127 may directly engage (or extend into) a radially inner surface of the mold 100 that is associated with the sipe blade 120. As the radially inner surface of the mold 100 may curve along its length, the radially outer edge 127 may correspondingly curve along its length, which enables the sipe blade 120 to properly and securely engage within the mold 100. Alternatively, the radially outer edge 127 may be straight as illustrated in FIG. 2.

The radial demarcation line 129 represents a radial demarcation between the mold engagement portion 123 and the molding portion 125. Because a radially inner edge 105 of the mold 100 at the shoulder-forming portion may include a curvature, the radial demarcation line 129 may mimic the curvature as it extends axially along the sipe blade 120. Thus, the radial height H_{E} of the mold engagement portion 123 may vary along the length L_{B} of the sipe blade 120.

The molding portion 125 includes a radial height H_{M} that extends from the radial demarcation line 129 to a radially inner edge 133 of the sipe blade 120. The radially inner edge 133 may form a bottom surface of a sipe in a tire tread upon molding of a tire. As the radial demarcation line 129 may mimic the curvature of the radially inner surface of the mold 100 as it extends axially along the sipe blade 120, the radial height H_{M} of the molding portion 125 may vary along the length L_{B} of the sipe blade 120.

While engaged within the mold 100, as illustrated in FIGS. 1A and 1B, an axially outer portion 121 of the mold engagement portion 123 is coupled to the mold 100. Specifically, the axially outer portion 121 is coupled to the mold 100 by both a radially outer edge and an axially outer edge, which creates a “fixed end.”

A corresponding axially outer portion 122 of the molding portion 125 protrudes radially inwardly from the mold 100, and thus, a radially inner edge and an axially outer edge are unsupported by a molding component or the mold 100. This is a result of a position of the sipe blade 120 at a shoulder-forming portion of the mold 100. As the shoulder-forming portion transitions to a sidewall-forming portion of the mold 100, the radially inner surface 105 of the mold 100 comprises a curvature. The axially outer portion 122 of the molding portion 125 of the sipe blade 120 does not engage within the radially inner surface 105 of the mold 100 where the shoulder-forming portion transitions to the sidewall-forming portion. Accordingly, a void 128 is created between the axially outer portion 122 of the molding portion 125 of the sipe blade 120 and the radially inner surface of the shoulder-forming portion of the mold 100.

In effect, the axially outer portion 122 of the molding portion 125 is cantilevered from the “fixed end,” or axially outer portion 121 of the mold engagement portion 123. Thus, the axially outer portion 122 of the molding portion 125 may bear a maximum of a load exerted on the axially outer portions 121 and 122 of the sipe blade 120. This phenomenon makes the axially outer portion 122 of the molding portion 125 particularly vulnerable to a material yield and a failure, including a shear failure and a tensile failure, during a tire mold production or a tire molding, including one or more of a tire mold casting, a tire mold casting, a tire de-molding, or the like. To prevent a failure, the sipe blade 120 is reinforced along the axially outer portion 121 of the mold engagement portion 123 and the axially outer portion 122 of the molding portion 125. Such reinforcement may reduce a force, such as pressure, exerted on the sipe blade 120 by between about 17% and 30%. Other portions along a length and height of a sipe blade may also be reinforced to prevent a failure or if desired, as further described below.

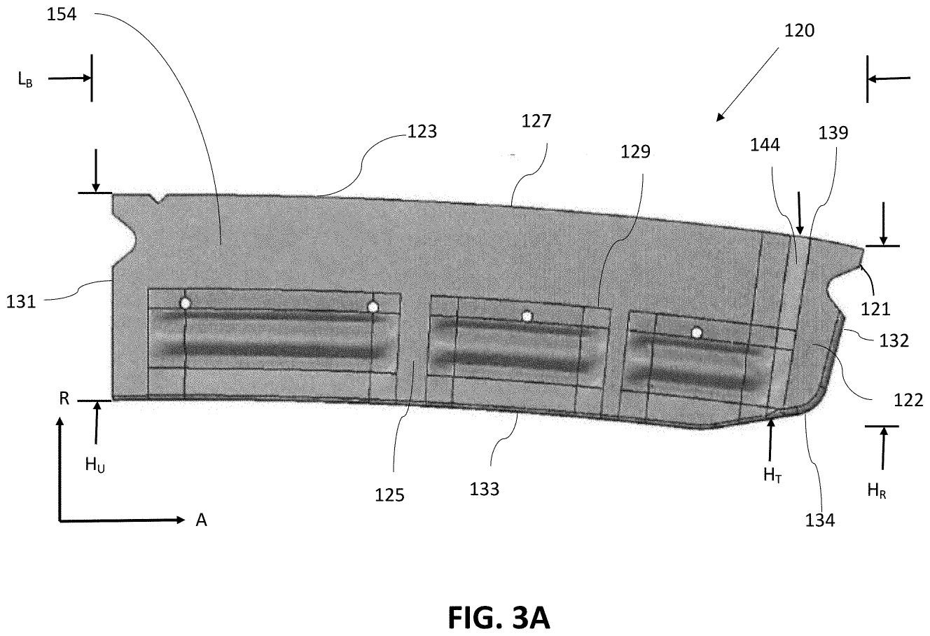

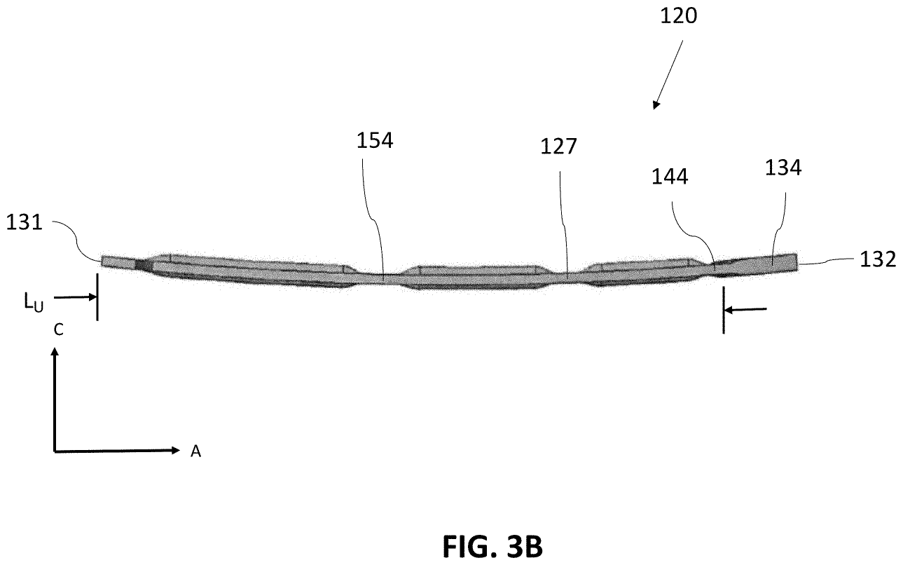

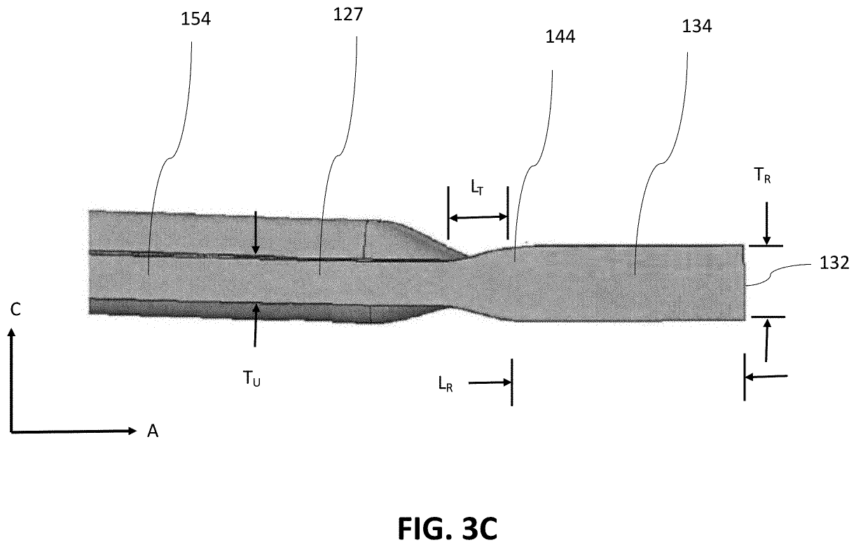

In a first implementation, as shown in FIGS. 3A-3C, the reinforced sipe blade 120 may include a reinforced end portion 134. The reinforced end portion 134 may comprise the axially outer portions 121 and 122, which require reinforcement, or an increased thickness, to prevent a material yield or a material failure of sipe blade 120 during a tire production or a tire molding, including one or more of a tire mold casting, a tire mold casting, a tire de-molding, or the like.

The reinforced end portion 134 has an axial length L_{R} that extends from the axially outer edge 132 of the sipe blade 120 to an axial demarcation line 139. The axial demarcation line 139 extends from the radially outer edge 127 to the radially inner edge of 133 the sipe blade 120, and indicates an axially inner boundary of the reinforced end portion 134. The axial demarcation line 139 may be one of parallel to the radial direction R or biased relative to the radial direction R. The axial demarcation line 139 may be one of parallel or biased relative to the axially outer edge 132. If the axial demarcation line 139 is biased relative to the axially outer edge 132, then the length L_{R} of the reinforced end portion 134 may vary along a radial height of the sipe blade 120.

The length L_{R} of the reinforced end portion 134 is less than the length L_{B} of the sipe blade 120. The length L_{B} extends between the axially inner edge 131 and the axially outer edge 132 of the sipe blade 120. The length L_{B} corresponds to a length of conventional sipe blades.

A radial height H_{R} of the reinforced sipe blade 120 extends from the radially outer edge 127 to the radially inner edge 133 of the sipe blade 120. In some implementations, the height H_{R} corresponds to a radial height of conventional sipe blades.

A circumferential thickness T_{R} of the reinforced end portion 134 may be substantially constant along its height H_{R}. The term “circumferential thickness” refers to a width of the sipe blade 120 in the circumferential direction C. As the reinforced end portion 134 is vulnerable to a failure, the thickness T_{R} must be great enough to provide a desired strength and a durability to the sipe blade 120 at this portion 134. In some implementations, the thickness T_{R} is 1.0 mm.

A tapered portion 144 extends axially inwardly from the reinforced end portion 134 at the axial demarcation line 139 to an axially outer end of an unreinforced main portion 154, which corresponds to its axial length L_{T}. In some implementations, the length L_{T} is 1.0 mm.

A radial height H_{T} of the tapered portion 144 extends from the radially outer edge 127 to the radially inner edge 133 of the sipe blade 120. In some implementations, the height H_{T} corresponds to the height H_{R} of the reinforced end portion 134. In other implementations, the height H_{T} is commensurate with a radial height of conventional sipe blades.

A circumferential thickness of the tapered portion 144 decreases or “tapers” along its length L_{T}. The thickness decreases from the thickness T_{R} of the reinforced end portion 134 to a thickness T_{U} of the unreinforced main portion 154, wherein the thickness T_{R} is greater than the thickness T_{U}. The sipe blade 120 includes the tapered portion 144 to avoid a stress concentration between the reinforced end portion 134 and the unreinforced main portion 154. This gradual change in thickness more evenly distributes forces acting over an area of the tapered portion 144, which prevents a failure at the tapered portion 144. In some implementations, the thickness T_{U} is 0.60 mm.

The unreinforced main portion 154, as illustrated in FIGS. 3B and 3C, extends axially inwardly from an axially inner end of the tapered portion 144 and comprises a remaining axial length L_{U} of the sipe blade 120. That is, the remaining length L_{U} extends axially inwardly from an axially inner end of the tapered portion 144 to the axially inner edge 131 of the sipe blade 120.

The unreinforced main portion 154 has a radial height H_{U} that extends from the radially outer edge 127 to the radially inner edge 133 of the sipe blade 120. In some implementations, the height H_{U} corresponds to a radial height of conventional sipe blades. In other implementations, the height H_{U} is commensurate with the height H_{R} of the reinforced end portion 134. In additional implementations, the height H_{U} is commensurate with the height H_{T} of the tapered portion 144.

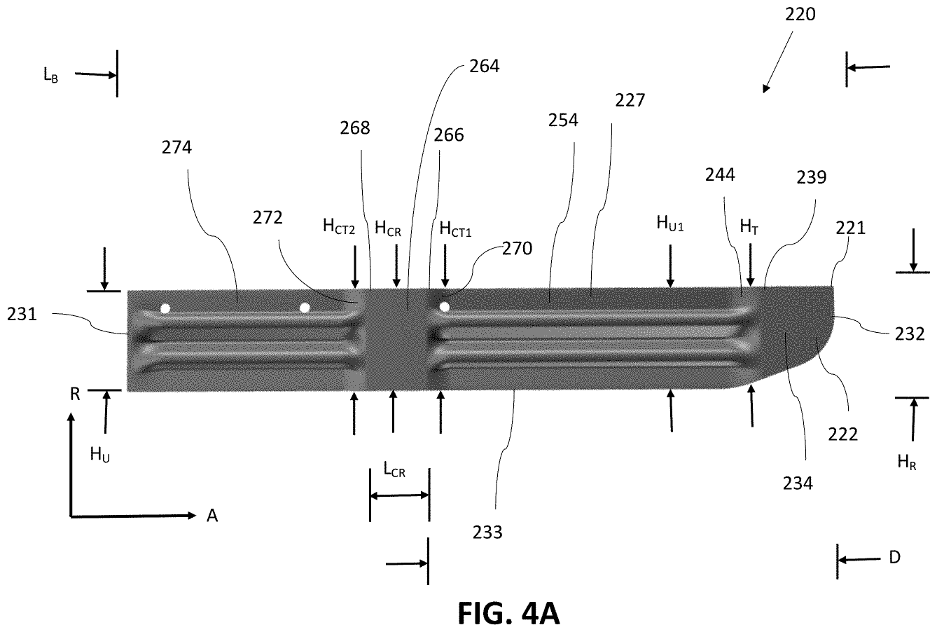

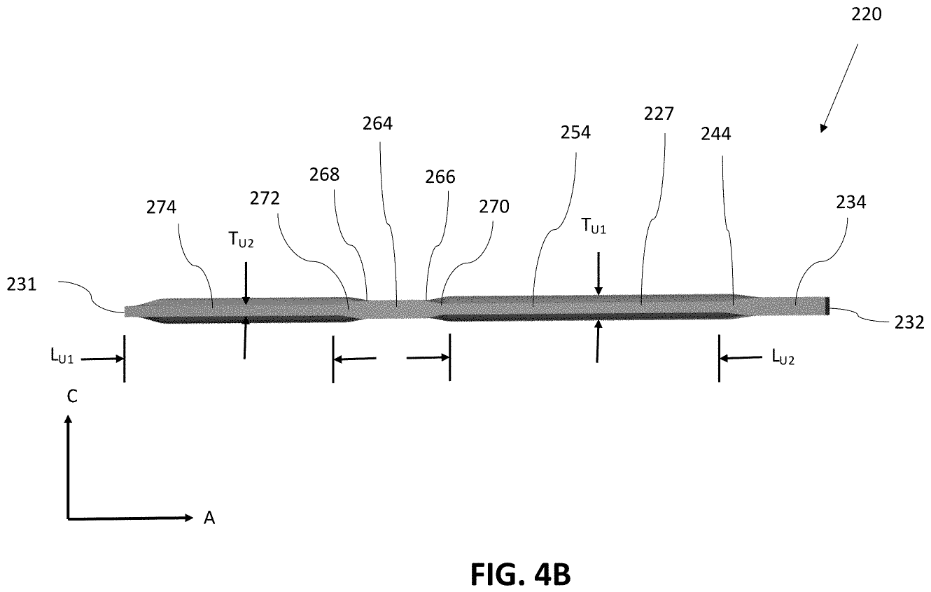

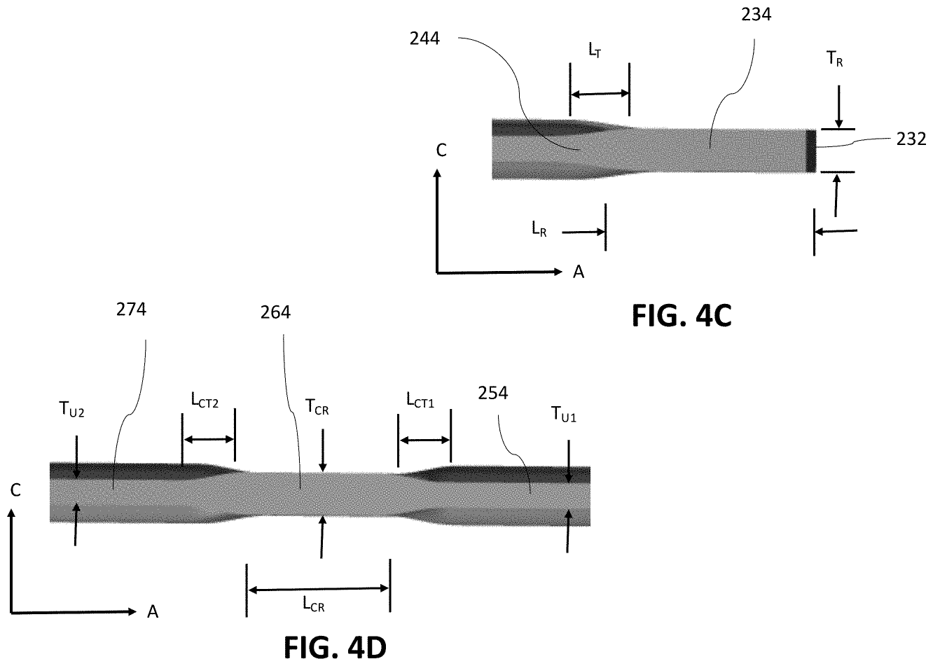

FIGS. 4A-4D depict a second implementation of a reinforced sipe blade 220. In the figures, like numerals represent features corresponding structurally and functionally to features in the first implementation. The sipe blade 220 may include a reinforced end portion 234. The reinforced end portion 234 may comprise axially outer portions 221 and 222, which require reinforcement, or an increased thickness, to prevent a material yield or a material failure during one or more of a tire production or a tire molding, including one or more of a tire mold casting, a tire mold casting, a tire de-molding, or the like.

The reinforced end portion 234 has an axial length L_{R} that extends from the axially outer edge 232 of the sipe blade 220 to an axial demarcation line 239. The axial demarcation line 239 extends radially from the radially outer edge 227 to the radially inner edge of the sipe blade 220, and indicates an axially inner boundary of the reinforced end portion 234. The axial demarcation line 239 may be one of parallel to the radial direction R or biased relative to the radial direction R. The axial demarcation line 239 may be one of parallel or biased relative to the axially outer edge 232. If the axial demarcation line 239 is biased relative to the axially outer edge 232, then the length L_{R} of the reinforced end portion 234 may vary along a radial height of the sipe blade 220.

The length L_{R} of the reinforced end portion 234 is less than an axial length L_{B} of the sipe blade 220. The length L_{B} extends axially between an axially inner edge 231 and an axially outer edge 232 of the sipe blade 220. In some implementations, the length L_{B} corresponds to a length of conventional sipe blades.

A radial height H_{R} of the reinforced end portion 234 extends from the radially outer edge 227 to the radially inner edge 233 of the sipe blade 220. In some implementations, the height H_{R} corresponds to a radial height of conventional sipe blades.

A circumferential thickness T_{R} of the reinforced end portion 234 may be substantially constant along its height H_{R}. As the reinforced end portion 234 is vulnerable to a failure, the thickness T_{R} must be great enough to provide a desired strength and a durability to the sipe blade 220 at this portion 234. In some implementations, the thickness T_{R} is 1.0 mm.

A tapered portion 244 extends axially inwardly from the reinforced end portion 234 at the axial demarcation line 239 to an axially outer end of a first unreinforced main portion 254, which corresponds to its axial length L_{T}. In some implementations, the length L_{T} is 1.0 mm.

A radial height H_{T} of the tapered portion 244 extends from the radially outer edge 227 to the radially inner edge 233 of the sipe blade 220. In some implementations, the height H_{T} corresponds to the height H_{R} of the reinforced end portion 234. In other implementations, the height H_{T} is commensurate with a radial height of conventional sipe blades.

A circumferential thickness of the tapered portion 244 decreases or “tapers” along its length L_{T}. The thickness decreases from the thickness T_{R} of the reinforced end portion 234 to a thickness T_{U1} of the first unreinforced main portion 254, wherein the thickness T_{R} is greater than the thickness T_{U1}. The sipe blade 220 includes the tapered portion 244 to avoid a stress concentration between the reinforced end portion 234 and the first unreinforced main portion 254. This gradual change in thickness more evenly distributes forces acting over an area of the tapered portion 244, which prevents a failure at the tapered portion 244. In some implementations, the thickness T_{U1} is 0.60 mm.

As illustrated in FIGS. 4B and 4C, the first unreinforced main portion 254 extends axially inwardly from an axially inner end of the tapered portion 244. An axial length L_{U1} of the first unreinforced main portion 254 extends axially inwardly from the axially inner end of the tapered portion 244 to about a central reinforced portion 264.

The first unreinforced main portion 254 has a radial height H_{U1} that extends from the radially outer edge 227 to the radially inner edge 233 of the sipe blade 220. In some implementations, the height H_{U1} corresponds to a radial height of conventional sipe blades.

The central reinforced portion 264 is substantially similar to the reinforced end portion 234. The term “central” in “central reinforced portion” indicates that the central reinforced portion 264 may be positioned at any location between the axially inner end of the tapered portion 244 and the axially inner edge 231 of the sipe blade 220. Its position is not required to be located at a midpoint of the length L_{B} of the sipe blade 220.

Reinforcement, or a greater thickness, of the sipe blade 200 at the central reinforced portion 264 may be desired, for example, if a portion contiguous or proximate to the central reinforced portion 264 is manufactured to have a thickness that is less than the thickness T_{U1} of the first unreinforced portion 254. Reinforcement, or a greater thickness, of the sipe blade 200 at the central reinforced portion 264 may be also be desired to generally increase a structural robustness of the sipe blade 220.

The central reinforced portion 264 may have a first end 266 and a second end 268. The first end 266 is positioned at an axially outer side of the central reinforced portion 264 and defines an axially outer boundary of the central reinforced portion 264. The second end 268 is positioned at an axially inner side of the central reinforced portion 264 and defines an axially inner boundary of the central reinforced portion 264.

An axial length L_{CR} of the central reinforced portion 264 extends from the first end 266 to the second end 268. The length L_{CR} of the central reinforced portion 264 is less than the length L_{B} of the sipe blade 220. Additionally, the length L_{CR} is one of greater than, less than, or substantially equal to the length L_{R} of the reinforced end portion 234.

The central reinforced portion 264 also has a radial height H_{CR} that extends from the radially outer edge 227 to the radially inner edge 233 of the sipe blade 220. In some implementations, the height H_{CR} corresponds to a radial height of conventional sipe blades. In other implementations, the height H_{CR} is substantially equal to the height H_{R} of the first reinforced end portion 234.

A circumferential thickness T_{CR} of the central reinforced portion 264 may be substantially constant along its height H_{CR}. As the central reinforced end portion 264 may be vulnerable to a failure, the thickness T_{CR} must be great enough to provide a desired strength and a durability to the sipe blade 220 at this portion 264. In some implementations, the thickness T_{CR} is 1.0 mm.

The central reinforced portion 264 may be separated from the reinforced end portion 234 by an axial distance D. The distance D may be measured from the axially outer edge 232 of the sipe blade 220 to the first end 266 of the central reinforced portion 264. The distance D is less than the length L_{B} of the sipe blade 220.

A first central tapered portion 270 extends axially outwardly from the first end 266 of the central reinforced portion 264 to an axially inner end of the first unreinforced main portion 254. The first central tapered portion 270 may have an axial length L_{CT1} that extends axially from the first end 266 of the central reinforced portion 264 to an axially inner end of the first unreinforced main portion 254. In some implementations, the length L_{CT1} is 1.0 mm. In other implementations, the length L_{CT1} may be one of greater than, less than, or substantially equal to the length L_{T} of the tapered portion 244.

A radial height H_{CT1} of the first central tapered portion 270 extends from the radially outer edge 227 to the radially inner edge 233 of the sipe blade 220. In some implementations, the height H_{CT1} corresponds to the height H_{CR} of the central reinforced portion 264. In other implementations, the height H_{CT1} is commensurate with a radial height of conventional sipe blades.

A circumferential thickness of the first central tapered portion 270 decreases or “tapers” along its length L_{CT1}. The thickness decreases from the thickness T_{CR} of the central reinforced portion 264 to the thickness T_{U1} of the first unreinforced main portion 254, wherein the thickness T_{CR} is greater than the thickness T_{U1}. The sipe blade 220 includes the first central tapered portion 270 to avoid a stress concentration between the first unreinforced main portion 254 and the central reinforced portion 264. This gradual change in thickness more evenly distributes forces acting over an area of the first central tapered portion 270, which prevents a failure at the first central tapered portion 270. In some implementations, the thickness T_{U1} is 0.60 mm.

A second central tapered portion 272 extends axially inwardly from the second end 268 of the central reinforced portion 264 to an axially outer end of a second unreinforced main portion 274. An axial length L_{CT2} of the second central tapered portion 272 extends from the second end 268 of the central reinforced portion 264 to an axially outer end of the second unreinforced main portion 274. In some implementations, the length L_{CT2} is 1.0 mm. In other implementations, the length L_{CT2} is one of greater than, less than, or substantially equal to the length L_{T} of the tapered portion 244. In further implementations, the length L_{CT2} is one of greater than, less than, or substantially equal to the length L_{CT1} of the first central tapered portion 270.

A radial height H_{CT2} of the second central tapered portion 272 extends from the radially outer edge 227 to the radially inner edge 233 of the sipe blade 220. In some implementations, the height H_{CT2} corresponds to the height H_{CT1} of the first central tapered portion 270. In further implementations, the height H_{CT2} corresponds to the height H_{T} of the tapered portion 244. In other implementations, the height H_{CT2} corresponds to the height H_{R} of the reinforced end portion 234. In further implementations, the height H_{CT2} corresponds to the height H_{CR} of the central reinforced portion 264. In other implementations, the height H_{CT2} is commensurate with a radial height of conventional sipe blades.

A circumferential thickness of the second central tapered portion 272 decreases or “tapers” along its length L_{CT2}. The thickness decreases from the thickness T_{CR} of the central reinforced portion 264 to a thickness T_{U2} of the second unreinforced main portion 274, wherein the thickness T_{CR} is greater than the thickness T_{U2}. The sipe blade 220 includes the second central tapered portion 272 to avoid a stress concentration between the second unreinforced main portion 274 and the central reinforced portion 264. This gradual change in thickness more evenly distributes forces acting over an area of the second central tapered portion 272, which prevents a failure at the second central tapered portion 272. In some implementations, the thickness T_{U2} is 0.60 mm. In other implementations, the thickness T_{U2} is one of greater than, less than, or substantially equal to the thickness T_{U1} of the first central tapered portion, but less than the thickness T_{CR} of the central reinforced portion 264 and the thickness T_{R} of the reinforced end portion 234.

The second unreinforced main portion 274 extends axially inwardly from an axially inner end of the second central tapered portion 272 and comprises a remaining axial length L_{U2} of the sipe blade 220. An axial length L_{U2} of the second unreinforced main portion 274 extends axially inwardly from the axially inner end of the second tapered portion 272 to the axially inner edge 232 of the sipe blade 220. In other implementations, the length L_{U2} is one of greater than, less than, or substantially equal to the length L_{U1} of the first unreinforced end portion 254.

The second unreinforced main portion 274 has a radial height H_{U2} that extends from the radially outer edge 227 to the radially inner edge 233 of the sipe blade 220. In some implementations, the height H_{U2} corresponds to a radial height of conventional sipe blades. In other implementations, the height H_{U2} corresponds to the height H_{CR} of the central reinforced portion 264. In further implementations, the height H_{U2} corresponds to the height H_{CT2} of the second central tapered portion 272.

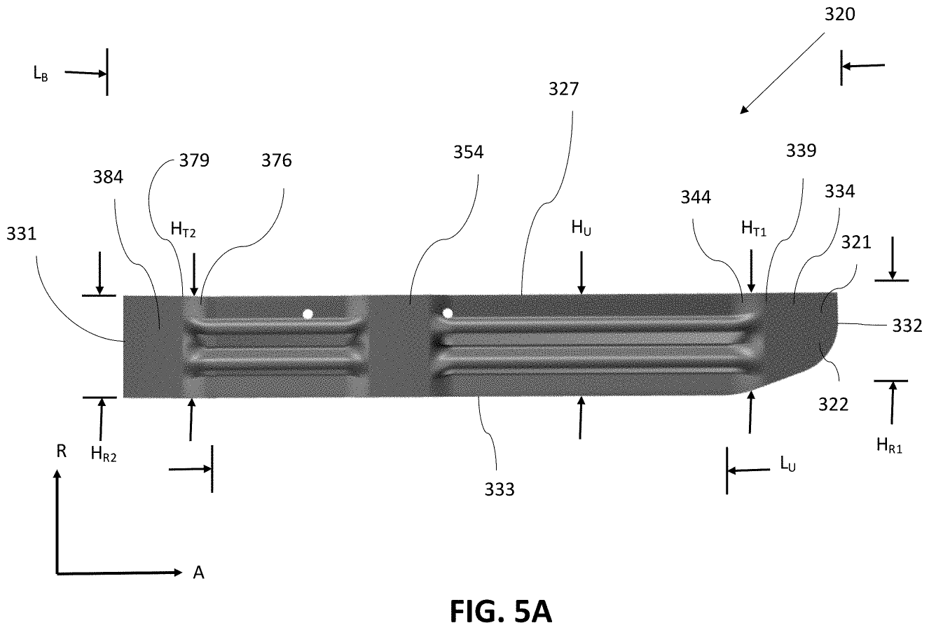

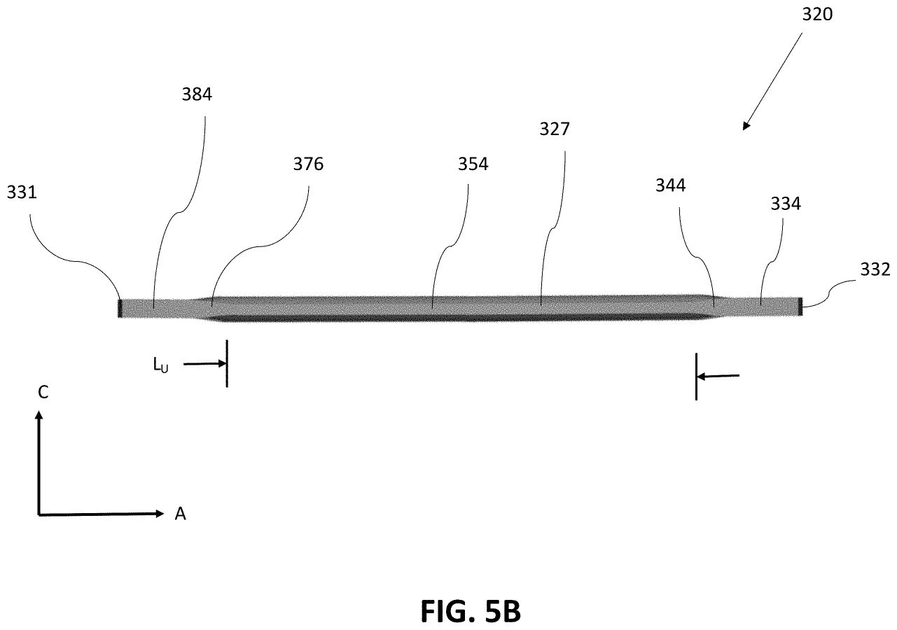

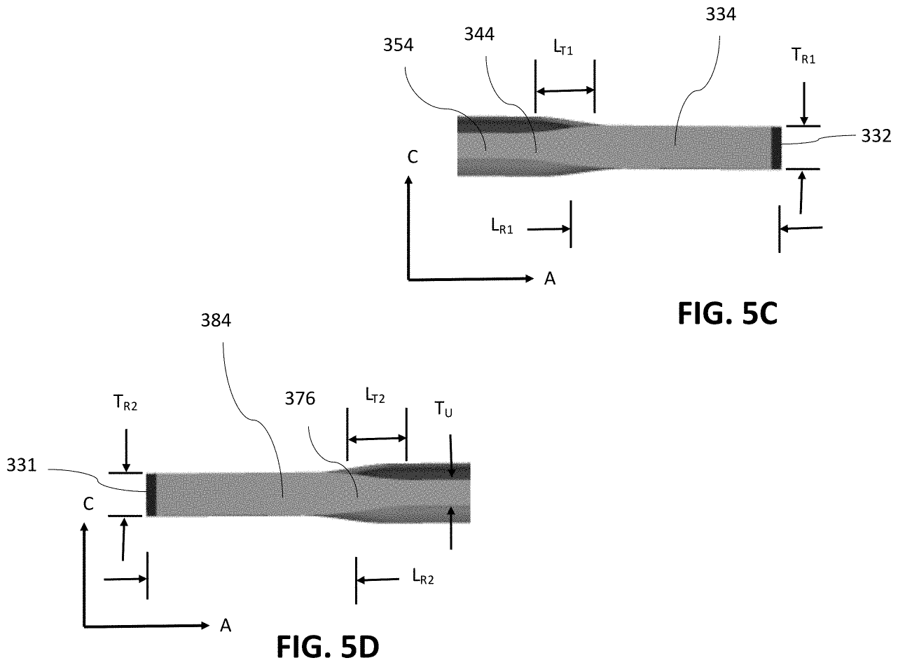

A third implementation of a reinforced sipe blade 320 is depicted in FIGS. 5A-5D. In the figures, like numerals represent features corresponding structurally and functionally to features in the first implementation. The sipe blade 320 may include a first reinforced end portion 334. The first reinforced end portion 334 may comprise axially outer portions 321 and 322, which require reinforcement, or an enhanced thickness, to prevent a material yield or a material failure during a tire production or a tire molding, including one or more of a tire mold casting, a tire mold casting, a tire de-molding, or the like.

The first reinforced end portion 334 has an axial length L_{R1} that extends from the axially outer edge 332 of the sipe blade 320 to a first axial demarcation line 339. The first axial demarcation line 339 extends radially from the radially outer edge 327 to the radially inner edge of the sipe blade 320, and indicates an axially inner boundary of the first reinforced end portion 334. The first axial demarcation line 339 may be one of parallel to the radial direction R or biased relative to the radial direction R. The first axial demarcation line 339 may be one of parallel or biased relative to the axially outer edge 332. If the first axial demarcation line 339 is biased relative to the axially outer edge 332, then the length L_{R1} of the first reinforced end portion 334 may vary along a radial height of the sipe blade 320.

The length L_{R1} of the first reinforced end portion 334 is less than an axial length L_{B} of the sipe blade 320. The length L_{B} extends between the axially inner edge 331 and the axially outer edge 332 of the sipe blade 320. In some implementations, the length L_{B} corresponds to a length of conventional sipe blades.

The radial height H_{R1} of the first reinforced end portion 334 extends from the radially outer edge 227 to the radially inner edge 233 of the sipe blade 320. In some implementations, the height H_{R1} corresponds to a radial height of conventional sipe blades.

A circumferential thickness T_{R1} of the first reinforced end portion 334 may be substantially constant along its height H_{R1}. As the first reinforced end portion 334 is vulnerable to a failure, the thickness T_{R1} must be great enough to provide a desired strength and a durability to the sipe blade 320 at this portion 334. In some implementations, the thickness T_{R1} is 1.0 mm.

A first tapered portion 344 extends axially inwardly from the first reinforced end portion 334 at the first axial demarcation line 339 to an axially outer end of a first unreinforced main portion 354, which corresponds to its axial length L_{T1}. In some implementations, the length L_{T1} is 1.0 mm.

A radial height H_{T1} of the first tapered portion 344 extends from the radially outer edge 327 to the radially inner edge 333 of the sipe blade 320. In some implementations, the height H_{T1} corresponds to the height H_{R1} of the first reinforced end portion 334. In other implementations, the height H_{T1} is commensurate with a radial height of conventional sipe blades.

A circumferential thickness of the first tapered portion 344 decreases or “tapers” along its length L_{T1}. The thickness decreases from the thickness T_{R1} of the first reinforced end portion 334 to a thickness T_{U} of the unreinforced main portion 354, wherein the thickness T_{R1} is greater than the thickness T_{U}. The sipe blade 320 includes the first tapered portion 344 to avoid a stress concentration between the first reinforced end portion 334 and the unreinforced main portion 354. This gradual change in thickness more evenly distributes forces acting over an area of the first tapered portion 344, which prevents a failure at the first tapered portion 344. In some implementations, the thickness T_{U} is 0.60 mm.

As illustrated in FIGS. 5B and 5C, the unreinforced main portion 354 extends axially inwardly from an axially inner end of the first tapered portion 344. An axial length L_{U} of the unreinforced main portion 354 extends axially inwardly from the axially inner end of the unreinforced main portion 354 to an axially outer end of a second tapered portion 376.

The unreinforced main portion 354 has a radial height H_{U} that extends from the radially outer edge 327 to the radially inner edge 333 of the sipe blade 320. In some implementations, the height H_{U} corresponds to a radial height of conventional sipe blades.

The second tapered portion 376 extends axially inwardly from the unreinforced main portion 354 to a second axial demarcation line 379, which corresponds to its axial length L_{T2}. In some implementations, the length L_{T2} is 1.0 mm. The second axial demarcation line 379 extends radially from the radially outer edge 327 to the radially inner edge of the sipe blade 320, and indicates an axially outer boundary of the second tapered portion 376. The second axial demarcation line 379 may be one of parallel to the radial direction R or biased relative to the radial direction R. The second axial demarcation line 379 may be one of parallel or biased relative to the axially inner edge 333. If the second axial demarcation line 379 is biased relative to the axially inner edge 333, then the length L_{T2} of the second tapered portion 376 may vary along a radial height of the sipe blade 320.

A radial height H_{T2} of the second tapered portion 376 extends from the radially outer edge 327 to the radially inner edge 333 of the sipe blade 320. In some implementations, the height H_{T2} corresponds to the height H_{T1} of the first tapered portion 344. In other implementations, the height H_{T2} is commensurate with a radial height of conventional sipe blades.

A circumferential thickness of the second tapered portion 376 increases along its length L_{T2}. The length L_{T2} is measured from an axially inner end of the unreinforced main portion 354 to the second axial demarcation line 379. The thickness of the second tapered portion increases from a circumferential thickness T_{U} of the unreinforced main portion 354 to a circumferential thickness T_{R2} of a second reinforced end portion 384, wherein the thickness T_{R2} is greater than the thickness T_{U}. The sipe blade 320 includes the second tapered portion 376 to avoid a stress concentration between the unreinforced main portion 354 and the second reinforced end portion 384. This gradual change in thickness more evenly distributes forces acting over an area of the second tapered portion 376, which prevents a failure at the second tapered portion 376. In some implementations, the thickness T_{U} is 0.60 mm.

The second reinforced end portion 384 is substantially similar to the first reinforced end portion 334 and is positioned axially opposite relative to the first reinforced end portion 334 at an axially inner side of the sipe blade 320. Reinforcement, or a greater thickness, of the sipe blade 300 at the second reinforced end portion 384 may be desired, for example, if a portion contiguous or proximate to the second reinforced end portion 384 is manufactured to have a thickness that is less than the thickness T_{U} of the unreinforced main portion 354. Reinforcement, or a greater thickness, of the sipe blade 300 at the second reinforced end portion 384 may be also be desired to generally increase a structural robustness of the sipe blade 300.

The second reinforced end portion 384 has an axial length L_{R2} that extends axially from the second axial demarcation line 379 to an axially inner edge 332 of the sipe blade 320. If the second axial demarcation line 379 is biased relative to the axially outer edge 332, then the length L_{R2} of the second reinforced end portion 334 may vary along a radial height of the sipe blade 320.

The length L_{R2} of the second reinforced end portion 384 is less than the length L_{B} of the sipe blade 320. In some implementations, the length L_{B} corresponds to a length of conventional sipe blades. In further implementations, the length L_{R2} is one of greater than, less than, or substantially equal to the length L_{R1} of the first reinforced end portion 334.

A radial height H_{R2} of the second reinforced end portion 384 extends from the radially outer edge 327 to the radially inner edge 333 of the sipe blade 320. In some implementations, the height H_{R2} corresponds to a radial height of conventional sipe blades. In another implementation, the height H_{R2} corresponds to the height H_{R1} of the first reinforced portion 334. In an additional implementation, the height H_{R2} corresponds to the height H_{RC} of the central reinforced portion 364.

A circumferential thickness T_{R2} of the second reinforced end portion 384 may be substantially constant along its height H_{R2}. In some implementations, the thickness T_{R2} is 1.0 mm. In further implementations, the thickness T_{R2} is one of greater than, less than, or substantially equal to the thickness T_{R1} of the first reinforced end portion 334.

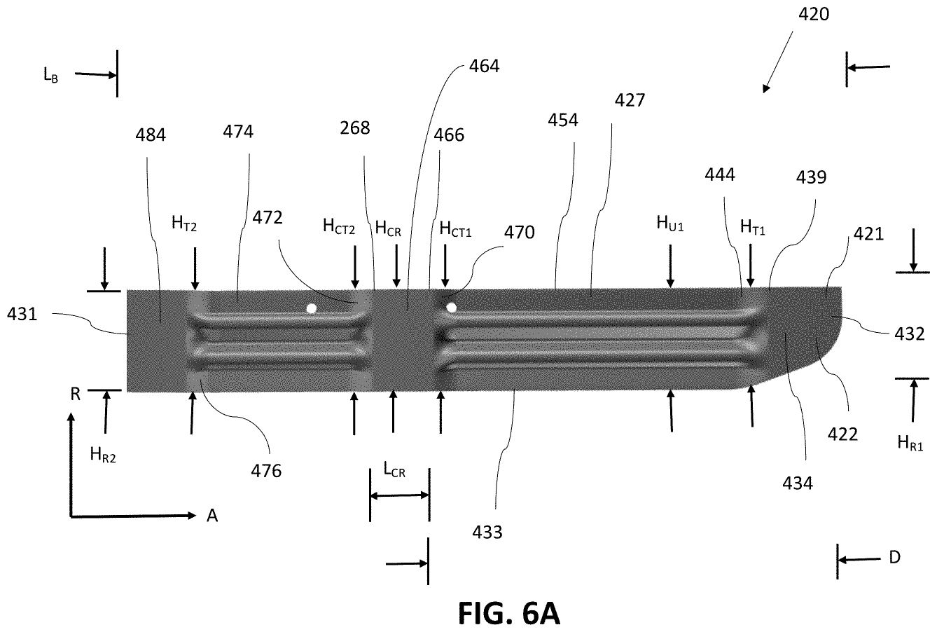

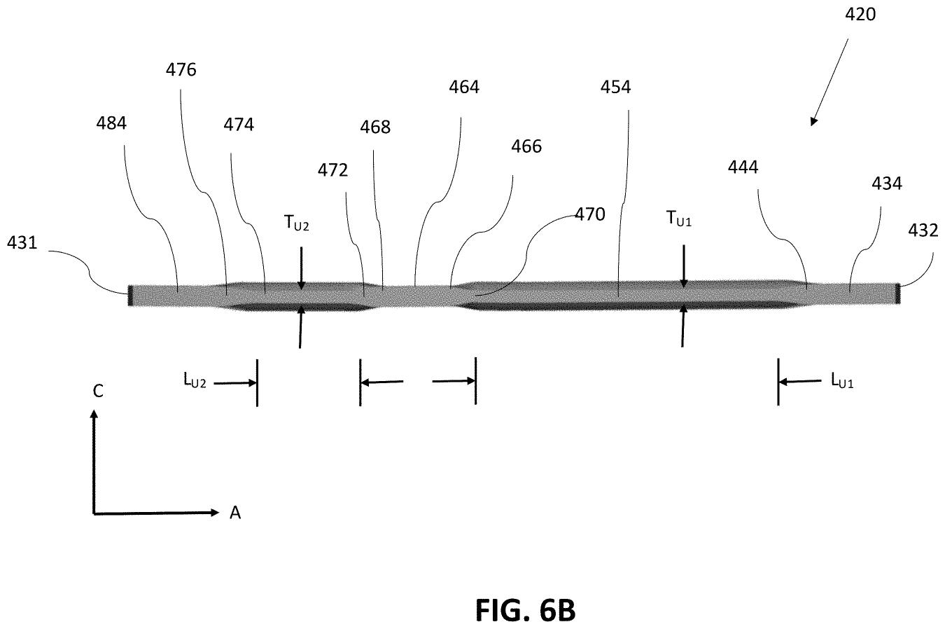

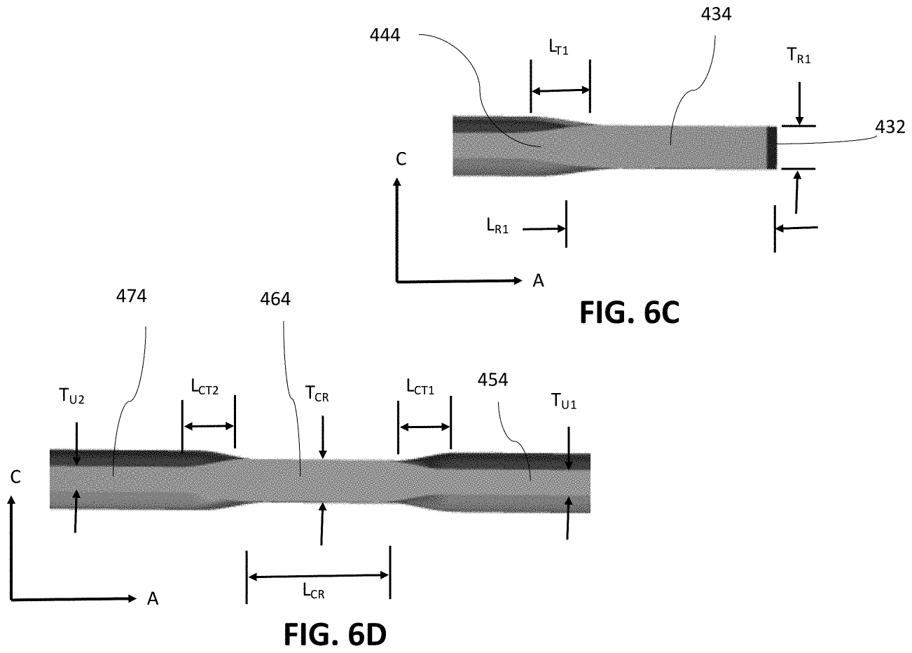

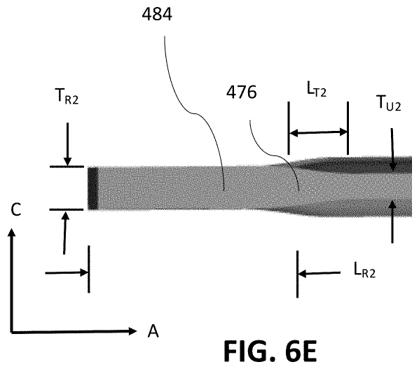

A fourth implementation of a reinforced sipe blade 420 is depicted in FIGS. 6A-6E. In the figures, like numerals represent features corresponding structurally and functionally to features in the first, second, and third implementation. The sipe blade 420 combines the features of the first, second, and third implementations.

The sipe blade 420 may include a first reinforced end portion 434. The first reinforced end portion 434 may comprise axially outer portions 421 and 422, which require reinforcement, or an increased thickness, to prevent a material yield or a material failure during one or more of a tire production or a tire molding, including one or more of a tire mold casting, a tire mold casting, a tire de-molding, or the like.

The first reinforced end portion 434 has an axial length L_{R1} that extends from the axially outer edge 432 of the sipe blade 420 to a first axial demarcation line 439. The first axial demarcation line 439 extends radially from the radially outer edge 427 to the radially inner edge of the sipe blade 420, and indicates an axially inner boundary of the first reinforced end portion 434. The first axial demarcation line 439 may be one of parallel to the radial direction R or biased relative to the radial direction R. The first axial demarcation line 439 may be one of parallel or biased relative to the axially outer edge 432. If the first axial demarcation line 439 is biased relative to the axially outer edge 332, then the length L_{R1} of the first reinforced end portion 434 may vary along a radial height of the sipe blade 420.

The length L_{R1} of the first reinforced end portion 434 is less than an axial length L_{B} of the sipe blade 420. The length L_{B} extends between the axially inner edge 431 and the axially outer edge 432 of the sipe blade 420. In some implementations, the length L_{B} corresponds to a length of conventional sipe blades.

The radial height H_{R1} of the first reinforced end portion 434 extends from the radially outer edge 427 to the radially inner edge 433 of the sipe blade 420. In some implementations, the height H_{R1} corresponds to a radial height of conventional sipe blades.

A circumferential thickness T_{R1} of the first reinforced end portion 434 may be substantially constant along its height H_{R1}. As the first reinforced end portion 434 is vulnerable to a failure, the thickness T_{R1} must be great enough to provide a desired strength and a durability to the sipe blade 420 at this portion 434. In some implementations, the thickness T_{R1} is 1.0 mm.

A first tapered portion 444 extends axially inwardly from the first reinforced end portion 434 at the first axial demarcation line 439 to an axially outer end of a first unreinforced main portion 454, which corresponds to its axial length L_{T1}. In some implementations, the length L_{T1} is 1.0 mm.

A radial height H_{T1} of the first tapered portion 444 extends from the radially outer edge 427 to the radially inner edge 433 of the sipe blade 420. In some implementations, the height H_{T1} corresponds to the height H_{T1} of the first reinforced end portion 434. In other implementations, the height H_{T1} is commensurate with a radial height of conventional sipe blades.

A circumferential thickness of the first tapered portion 444 decreases or “tapers” along its length L_{T1}. The thickness decreases from the thickness T_{R1} of the first reinforced end portion 434 to a thickness T_{U1} of the first unreinforced main portion 454, wherein the thickness T_{R1} is greater than the thickness T_{U1}. The sipe blade 420 includes the first tapered portion 444 to avoid a stress concentration between the first reinforced end portion 434 and the first unreinforced main portion 454. This gradual change in thickness more evenly distributes forces acting over an area of the first tapered portion 444, which prevents a failure at the first tapered portion 444. In some implementations, the thickness T_{U1} is 0.60 mm.

As illustrated in FIGS. 6B and 6C, the first unreinforced main portion 454 extends axially inwardly from an axially inner end of the first tapered portion 444. An axial length L_{U1} of the first unreinforced main portion 454 extends axially inwardly from the axially inner end of the tapered portion 444 to about a central reinforced portion 464.

The first unreinforced main portion 454 has a radial height H_{U1} that extends from the radially outer edge 427 to the radially inner edge 433 of the sipe blade 420. In some implementations, the height H_{U1} corresponds to a radial height of conventional sipe blades.

The central reinforced portion 464 is substantially similar to the first reinforced end portion 434. The term “central” in “central reinforced portion” indicates that the central reinforced portion 464 may be positioned at any location between the axially inner end of the first tapered portion 444 and the axially inner edge 431 of the sipe blade 420. Its position is not required to be located at a midpoint of the length L_{B} of the sipe blade 420.

The central reinforced portion 464 may have a first end 466 and a second end 468. The first end 466 is positioned at an axially outer side of the central reinforced portion 464 and defines an axially outer boundary of the central reinforced portion 464. The second end 268 is positioned at an axially inner side of the central reinforced portion 464 and defines an axially inner boundary of the central reinforced portion 464.

An axial length L_{CR} of the central reinforced portion 464 extends from the first end 466 to the second end 468. The length L_{CR} of the central reinforced portion 464 is less than the length L_{B} of the sipe blade 420. Additionally, the length L_{CR} is one of greater than, less than, or substantially equal to the length L_{R} of the first reinforced end portion 434.

The central reinforced portion 464 also has a radial height H_{CR} that extends from the radially outer edge 427 to the radially inner edge 433 of the sipe blade 420. In some implementations, the height H_{CR} corresponds to a radial height of conventional sipe blades. In other implementations, the height H_{CR} is substantially equal to the height H_{R} of the first reinforced end portion.

A circumferential thickness T_{CR} of the central reinforced portion 464 may be substantially constant along its height H_{CR}. As the central reinforced portion 464 is vulnerable to a failure, the thickness T_{CR} must be great enough to provide a desired strength and a durability to the sipe blade 420 at this portion 464. In some implementations, the thickness T_{CR} is 1.0 mm.

The central reinforced portion 464 may be separated from the first reinforced end portion 434 by an axial distance D. The distance D may be measured from the axially outer edge 432 of the sipe blade 420 to the first end 466 of the central reinforced portion 464. The distance D is less than the length L_{B} of the sipe blade 420.

A first central tapered portion 470 extends axially outwardly from the first end 466 of the central reinforced portion 464 to an axially inner end of the first unreinforced main portion 454. The first central tapered portion 470 may have an axial length L_{CT1} that extends axially from the first end 466 of the central reinforced portion 464 to an axially inner end of the first unreinforced main portion 454. In some implementations, the length L_{CT1} is 1.0 mm. In other implementations, the length L_{CT1} may be one of greater than, less than, or substantially equal to the length L_{T1} of the first tapered portion 244.

A radial height H_{CT1} of the first central tapered portion 470 extends from the radially outer edge 427 to the radially inner edge 433 of the sipe blade 420. In some implementations, the height H_{CT1} corresponds to the height H_{R1} of the first reinforced end portion 434. In other implementations, the height H_{CT1} is commensurate with a radial height of conventional sipe blades.

A circumferential thickness of the first central tapered portion 470 decreases or “tapers” along its length L_{CT1}. The thickness decreases from the thickness T_{CR} of the central reinforced portion 464 to the thickness T_{U1} of the first unreinforced main portion 454, wherein the thickness T_{CR} is greater than the thickness T_{U}. The sipe blade 420 includes the first central tapered portion 470 to avoid a stress concentration between the first unreinforced main portion 454 and the central reinforced portion 464. This gradual change in thickness more evenly distributes forces acting over an area of the first central tapered portion 470, which prevents a failure at the first central tapered portion 470. In some implementations, the thickness T_{U1} is 0.60 mm.

A second central tapered portion 472 extends axially inwardly from the second end 468 of the central reinforced portion 464 to an axially outer end of a second unreinforced main portion 474. An axial length L_{CT2} of the second central tapered portion 472 extends from the second end 268 of the central reinforced portion 464 to an axially outer end of the second unreinforced main portion 474. In some implementations, the length L_{T} is 1.0 mm. In other implementations, the length L_{CT2} is one of greater than, less than, or substantially equal to the length L_{T} of the tapered portion 444. In further implementations, the length L_{CT2} is one of greater than, less than, or substantially equal to the length L_{CT1} of the first central tapered portion 470.

A radial height H_{CT2} of the second central tapered portion 472 extends radially from the radially outer edge 427 to the radially inner edge 433 of the sipe blade 420. In some implementations, the height H_{CT2} corresponds to the height H_{CT1} of the first central reinforced portion 464. In other implementations, the height H_{CT2} corresponds to the height H_{R1} of the first reinforced end portion 434. In further implementations, the height H_{CT2} is commensurate with a radial height of conventional sipe blades.

A circumferential thickness of the second central tapered portion 472 decreases or “tapers” along its length L_{CT2}. The thickness decreases from the thickness T_{CR} of the central reinforced portion 264 to a thickness T_{U2} of the second unreinforced main portion 484, wherein the thickness T_{CR} is greater than the thickness T_{U2}. The sipe blade 420 includes the first second tapered portion 472 to avoid a stress concentration between the second unreinforced main portion 454 and the central reinforced portion 464. This gradual change in thickness more evenly distributes forces acting over an area of the second central tapered portion 472, which prevents a failure at the second central tapered portion 470. In some implementations, the thickness T_{U2} is 0.60 mm. In other implementations, the thickness T_{U2} is one of greater than, less than, or substantially equal to the thickness T_{U1} of the first central tapered portion, but less than the thickness T_{CR} of the central reinforced portion 464 and the thickness T_{R1} of the first reinforced end portion 434.

The second unreinforced main portion 474 extends axially inwardly from an axially inner end of the second central tapered portion 472 and comprises a remaining axial length L_{U2} of the sipe blade 420. An axial length L_{U2} of the second unreinforced main portion 474 extends axially inwardly from the axially inner end of the second tapered portion 272 to the axially inner edge 432 of the sipe blade 420. In other implementations, the length L_{U2} is one of greater than, less than, or substantially equal to the length L_{U1} of the first unreinforced end portion 454.

The second unreinforced main portion 474 has a radial height H_{U2} that extends from the radially outer edge 427 to the radially inner edge 433 of the sipe blade 420. In some implementations, the height H_{U2} corresponds to a radial height of conventional sipe blades.

The second tapered portion 476 extends axially inwardly from the second unreinforced main portion 474 to a second axial demarcation line 479, which corresponds to its axial length L_{T2}. In some implementations, the length L_{T2} is 1.0 mm. The second axial demarcation line 479 extends radially from the radially outer edge 427 to the radially inner edge of the sipe blade 420, and indicates an axially outer boundary of the second tapered portion 476. The second axial demarcation line 479 may be one of parallel to the radial direction R or biased relative to the radial direction R. The second axial demarcation line 479 may be one of parallel or biased relative to the axially inner edge 433. If the second axial demarcation line 479 is biased relative to the axially inner edge 433, then the length L_{T2} of the second tapered portion 476 may vary along a radial height of the sipe blade 420.

A radial height H_{T2} of the second tapered portion 476 extends from the radially outer edge 427 to the radially inner edge 433 of the sipe blade 420. In some implementations, the height H_{T2} corresponds to the height H_{T1} of the first tapered portion 444. In other implementations, the height H_{T2} is commensurate with a radial height of conventional sipe blades.

A circumferential thickness of the second tapered portion 476 increases along its length L_{T2}. The length L_{T2} is measured from an axially inner end of the second unreinforced main portion 474 to the second axial demarcation line 479. The thickness of the second tapered portion increases from a circumferential thickness T_{U2} of the second unreinforced main portion 474 to a circumferential thickness T_{R2} of a second reinforced end portion 484, wherein the thickness T_{R2} is greater than the thickness T_{U2}. The sipe blade 420 includes the second tapered portion 476 to avoid a stress concentration between the second unreinforced main portion 474 and the second reinforced end portion 484. This gradual change in thickness more evenly distributes forces acting over an area of the second tapered portion 476, which prevents a failure at the second tapered portion 476. In some implementations, the thickness T_{U2} is 0.60 mm. In other implementations, the thickness T_{U2} is one of substantially equal or equal to the thickness T_{U1} of the first unreinforced main portion 454.

The second reinforced end portion 484 is substantially similar to the first reinforced end portion 434 and is positioned axially opposite relative to the first reinforced end portion 434 at an axially inner side of the sipe blade 420. Reinforcement, or a greater thickness, of the sipe blade 420 at the second reinforced end portion 484 may be desired, for example, if a portion contiguous or proximate to the second reinforced end portion 484 is manufactured to have a thickness that is less than the thickness T_{U2} of the second unreinforced main portion 474. Reinforcement, or a greater thickness, of the sipe blade 420 at the second reinforced end portion 484 may be also be desired to generally increase a structural robustness of the sipe blade 420.

The second reinforced end portion 484 has an axial length L_{R2} that extends axially from the second axial demarcation line 479 to the axially inner edge 432 of the sipe blade 420. If the second axial demarcation line 479 is biased relative to the axially outer edge 432, then the length L_{R2} of the second reinforced end portion 434 may vary along a radial height of the sipe blade 420.

The length L_{R2} of the second reinforced end portion 484 is less than the length L_{B} of the sipe blade 420. In some implementations, the length L_{B} corresponds to a length of conventional sipe blades. In further implementations, the length L_{R2} is one of greater than, less than, or substantially equal to the length L_{R1} of the first reinforced end portion 434.

A radial height H_{R2} of the second reinforced end portion 484 extends from the radially outer edge 427 to the radially inner edge 433 of the sipe blade 420. In some implementations, the height H_{R2} corresponds to a radial height of conventional sipe blades. In another implementation, the height H_{R2} corresponds to the height H_{R1} of the first reinforced portion 434. In an additional implementation, the height H_{R2} corresponds to the height H_{RC} of the central reinforced portion 464.

A circumferential thickness T_{R2} of the second reinforced end portion 484 may be substantially constant along its height H_{R2}. In some implementations, the thickness T_{R2} is 1.0 mm. In further implementations, the thickness T_{R2} is one of greater than, less than, or substantially equal to the thickness T_{R1} of the first reinforced end portion 434.

What have been described above are implementations. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” feature, or the equivalent thereof, it should be interpreted to include one or more than one such feature, neither requiring nor excluding two or more such features. As used herein, the term “includes” means includes but not limited to, and the term “including” means including but not limited to. The term “based on” means based at least in part on.

What is claimed is:

1. A tire sipe blade comprising:
a mold engagement portion and a molding portion comprising:
a first reinforced end portion having a circumferential thickness T_{R1};
a first tapered portion extending from the first reinforced end portion and having an axial length L_{T1}; and
an unreinforced main portion extending from the first tapered portion and having a circumferential thickness T_{U},
wherein the thickness T_{R1} is greater than the thickness T_{U},
wherein a circumferential thickness of the first tapered portion decreases along its length L_{T1}, from the first reinforced end portion to the unreinforced main portion, from the thickness T_{R1} to the thickness T_{U}.

2. The tire sipe blade of claim 1, wherein the first reinforced end portion includes a radial height H_{R1}, and the thickness T_{R1} is substantially constant along the height H_{R1}.

3. The tire sipe blade of claim 1, wherein the unreinforced main portion includes a radial height H_{U}, and the thickness T_{U} is substantially constant along the height H_{U}.

4. The tire sipe blade of claim 1, further comprising a central reinforced portion, wherein the sipe blade has an axial length L_{B}, wherein the central reinforced portion is separated from the first reinforced end portion by an axial distance D, and wherein the distance D is less than the length L_{B}.

5. The tire sipe blade of claim 4, wherein the central reinforced portion has a first end and a second end,
wherein the first end has a first central tapered portion extending from the first end of the central reinforced portion to the unreinforced main portion,
wherein the second end has a has a second central tapered portion extending from the second end of the central reinforced portion to the unreinforced main portion.

6. The tire sipe blade of claim 4, wherein the central reinforced portion has a circumferential thickness T_{CR}, and wherein the thickness T_{CR} is greater than T_{U}.

7. The tire sipe blade of claim 5, wherein the first central tapered portion has an axial length L_{CT1} and a circumferential thickness that decreases along its length L_{CT1}, from the first central reinforced end portion to the unreinforced main portion, from the thickness T_{CR} to the thickness T_{U}.

8. The tire sipe blade of claim 5, wherein the second central tapered portion has an axial length L_{CT2} and a circumferential thickness that decreases along its length L_{CT2}, from the second central reinforced end portion to the unreinforced main portion, from the thickness T_{CR} to the thickness T_{U}.

9. The tire sipe blade of claim 5, wherein the central reinforced portion includes a radial height H_{CR} and the thickness T_{CR} is substantially constant along the height H_{CR}.

10. A tire sipe blade comprising:
a mold engagement portion and a molding portion comprising:
a first reinforced end portion having a circumferential thickness T_{R1};
a first tapered portion extending from the first reinforced end portion and having an axial length L_{T1}; and
an unreinforced main portion extending from the first tapered portion and having an axial length L_{U} and a circumferential thickness T_{U},
wherein the thickness T_{R1} is greater than the thickness T_{U},
wherein a circumferential thickness of the first tapered portion decreases along its length L_{T1}, from the first reinforced end portion to the unreinforced main portion, from the thickness T_{R1} to the thickness T_{U};
a central reinforced portion having a first end and a second end separated from the first reinforced end portion by an axial distance D,
wherein the sipe blade has an axial length L_{B} and the distance D is less than the length L_{B},
a first central tapered portion extending from the first end of the central reinforced portion to the unreinforced main portion, and
a second central tapered portion extending from the second end of the central reinforced portion to the unreinforced main portion.

11. The sipe blade of claim 10, wherein the central reinforced portion has a circumferential thickness T_{CR}, and wherein the thickness T_{CR} is greater than T_{U}.

12. The sipe blade of claim 10, wherein the first central tapered portion has an axial length L_{CT1} and a circumferential thickness that decreases along its length L_{CT1}, from the central reinforced portion to the unreinforced main portion, from the thickness T_{CR} to the thickness T_{U}.

13. The sipe blade of claim 10, wherein the second central tapered portion has an axial length L_{CT2} and a circumferential thickness that decreases along its length L_{CT2}, from the second central reinforced portion to the unreinforced main portion, from the thickness T_{CR} to the thickness T_{U}.

14. The sipe blade of claim 11, wherein the central reinforced portion includes a radial height HC, and the thickness TC is substantially constant along the height HC.

15. A tire sipe blade comprising:
a mold engagement portion and a molding portion comprising:
a first reinforced end portion having a circumferential thickness T_{R1};
a first tapered portion extending from the first reinforced end portion and having an axial length L_{T1}; and
an unreinforced main portion extending from the first tapered portion and having a circumferential thickness T_{U},
wherein the thickness T_{R1} is greater than the thickness T_{U},
wherein a circumferential thickness of the first tapered portion decreases along its length L_{T1}, from the first reinforced end portion to the unreinforced main portion, from the thickness T_{R1} to the thickness T_{U};
a second tapered portion extending from the unreinforced main portion and having an axial length L_{T2}; and
a second reinforced end portion extending from the second tapered portion and having a circumferential thickness T_{R2},
wherein the thickness T_{R2} is greater than the thickness T_{U},
wherein a circumferential thickness of the second tapered portion increases along its length L_{T2}, from the unreinforced main portion to the second reinforced end portion, from the thickness T_{U} to the thickness T_{R2}.

16. The sipe blade of claim 15, wherein the first reinforced end portion includes a radial height H_{R1}, and the thickness T_{R1} is substantially constant along the height H_{R1}.

17. The sipe blade of claim 15, wherein the unreinforced main portion includes a radial height H_{U}, and the thickness T_{U} is substantially constant along the height H_{U}.

18. The sipe blade of claim 15, wherein the second reinforced end portion includes a radial height H_{R2}, and the thickness T_{R2} is substantially constant along the height H_{R2}.

19. The sipe blade of claim 15, further comprising:
a central reinforced portion having a first end and a second end and separated from the first reinforced end portion by an axial distance D,
wherein the sipe blade has an axial length L_{B} and the distance D is less than the length L_{B},
a first central tapered portion extending from the first end of the central reinforced portion to the unreinforced main portion, and
a second central tapered portion extending from the second end of the central reinforced portion to the unreinforced main portion.

20. The sipe blade of claim 19, wherein the first central tapered portion has an axial length L_{CT1} and a circumferential thickness that decreases along its length L_{CT1}, from the first central reinforced end portion to the unreinforced main portion, from the thickness T_{C} to the thickness T_{U}, and
wherein the second central tapered portion has an axial length L_{CT2} and a circumferential thickness that decreases along its length L_{CT2}, from the second central reinforced end portion to the unreinforced main portion, from the thickness T_{C} to the thickness T_{U}.
